(19) United States
(12) Patent Application Publication
(10) Pub. No.: US 2025/0125529 A1
(43) Pub. Date: Apr. 17, 2025

(54) FISHING REEL

(71) Applicant: Shimano Inc., Osaka (JP)

(72) Inventors: Kunio TAKECHI, Osaka (JP); Hiroaki GODA, Osaka (JP)

(21) Appl. No.: 18/771,372

(22) Filed: Jul. 12, 2024

(30) Foreign Application Priority Data
Oct. 12, 2023 (JP) 2023-176605

(51) Int. Cl. H01Q 7/00; A01K 89/033

(52) U.S. Cl. CPC H01Q 7/00; A01K 89/033

(57) ABSTRACT

A fishing reel includes a reel body, a handle, a storage unit, a communication unit and a control unit. The handle is disposed on a first portion of the reel body. The storage unit is disposed in the reel body and stores setting information. The communication unit is disposed in a second portion of the reel body, which is separate from the first portion, and communicates with an external electronic device. The control unit causes the communication unit and the electronic device to communicate when the communication unit and the electronic device are disposed in a field capable of enabling Near Field wireless Communication, and updates the setting information of the storage control unit.

### CROSS-REFERENCE TO RELATED APPLICATIONS

This application claims priority to Japanese Patent Application No. 2023-176605, filed on Oct. 12, 2023. The entire disclosure of Japanese Patent Application No. 2023-176605 are hereby incorporated by reference.

### BACKGROUND

### Technical Field

The present disclosure relates to a fishing reel.

### Background Information

Communication methods that are configured to automatically carry out Near Field wireless Communication (NFC), when one electronic device enters a field in which it is possible to communicate with another electronic device, are known from the prior art (for example, refer to Japanese published unexamined application 2015-76775 Official Notice).

Fishing reels in which braking parameter settings can be changed using an electronic device external to the reel are known (for example, refer to Japanese Patent No. 7,166,895).

### SUMMARY

It has been determined that there is a need to restrict or avoid an increase in the size of a fishing reel such as the reels disclosed in Japanese published unexamined application 2015-76775 Official Notice and Japanese Patent No. 7,166,895, even if a communication unit that can improve communication efficiency, such as an antenna, is provided.

The present disclosure was conceived in light of these circumstances, and an object thereof is to provide a fishing reel in which it is possible to install a communication unit that can improve communication efficiency, such as an antenna, while restricting or avoiding an increase in the size of the reel.

A first aspect of a fishing reel according to the present disclosure comprises: a reel body that has a first portion and a second portion which is separate from the first portion; a handle provided on the first portion of the reel body; a storage unit that is provided in the reel body and that stores setting information; a communication unit that is provided in the second portion and that can communicate with an external electronic device; and a control unit that causes the communication unit and the electronic device to communicate when the communication unit and the electronic device enter a close field in which Near Field wireless Communication is possible, and that updates the setting information of the storage control unit.

By the first aspect of the fishing reel according to the present disclosure, if an electronic device such as a smartphone is brought close to a second portion (a portion separate from a first portion) of a reel body of a fishing reel, in which a communication unit such as an antenna is incorporated, Near Field wireless Communication is performed between the storage unit and the electronic device via the communication unit, and the electronic device can receive supply of power and update the setting information stored in the storage unit.

A second aspect of the present disclosure is the fishing reel according to the first aspect, wherein, preferably, the second portion is provided on a palming side which is the opposite side of the first portion, and the communication unit is provided on the palming side.

In this case, the communication unit is disposed in the palming side, which is not on the handle side. As a result, it is easier to bring an electronic device close to the communication unit provided on the palming side, and to more reliably perform Near Field wireless Communication.

A third aspect of the present disclosure is the fishing reel according to the first or second aspect, wherein, preferably, the communication unit is configured to have an annular shape and is provided around a spool shaft that is supported by the reel body.

In this case, the space around the spool shaft of a circuit board, for example, can be used to dispose the communication unit therein. That is, because the communication unit can be disposed on the circuit board, the thickness of the reel in the left-right direction can be reduced.

In addition, in this case, the communication unit can be disposed at a position to avoid a spool shaft supporting portion, such as a shaft bearing, and it is possible to reliably perform communication while minimizing the dimension by which the reel body protrudes toward the palming side.

A fourth aspect of the present disclosure is the fishing reel according to the first or second aspect, wherein the communication unit can be configured to have an annular shape and can be provided around a rotational shaft of a level winding device that moves a line guide unit in reciprocating manner.

In this case, because the space extends along on an extension line of the drive shaft of the level winding device, palming performance is not hindered or negatively impacted. In addition, it is possible to dispose a communication unit having an annular shape and composed of a small coil antenna with an increased number of turns in this space.

A fifth aspect of the present disclosure is the fishing reel according to any one of the first to the fourth aspects, wherein the communication unit has an antenna portion forming a pattern coil.

In this case, it is possible to easily form an antenna portion that has a pattern coil obtained by printing conductive paint, for example, on the substrate. It is thereby possible to stack the antenna portion on the circuit board, which has the advantage that the antenna shape can be made into a desired shape using the pattern coil. In this case, it is possible to improve efficient use of the space e of the communication unit disposed inside the reel body.

A sixth aspect of the present disclosure is the fishing reel according to the fifth aspect, wherein the antenna portion is a multilayer antenna portion forming a plurality of layers of the pattern coils.

In this case, by providing a multilayer antenna portion, it is possible to increase the inductor value, improving communication.

A seventh aspect of the present disclosure is the fishing reel according to any one of the first to the fourth aspects, wherein the communication unit can be an air core coil made of enameled wire.

In this case, since a communication unit made of an air core coil is simply disposed on an existing circuit board, the communication unit can be easily assembled. It is particularly effective if a space in the height direction (left-right direction) above the circuit board is provided.

An eighth aspect of the present disclosure is the fishing reel according to any one of the first to the seventh aspects, wherein a shielding part can be disposed between the communication unit and the storage unit.

In this case, it is possible for the communication unit to restrict the electrical influence smaller than the storage unit, and to adjust the inductor value to be larger.

By the fishing reel according to the present disclosure, it is possible to provide a communication unit that can improve communication efficiency, such as an antenna, while restricting or avoiding an increase in the size of the reel.

### BRIEF DESCRIPTION OF THE DRAWINGS

FIG. 1 is a perspective view of a dual-bearing reel according to a first embodiment of the present disclosure.

FIG. 2 is an exploded perspective view of a dual-bearing reel comprising a brake unit.

FIG. 3 is an exploded perspective view of a brake unit.

FIG. 4 is a partially exploded perspective view of a communication mechanism.

FIG. 5 is a plan view of an antenna portion of the communication mechanism shown in FIG. 4.

FIG. 6 is a perspective view of a communication mechanism of a dual-bearing reel according to a second embodiment.

FIG. 7 is an exploded perspective view showing a configuration in which a shielding sheet is provided in the communication mechanism shown in FIG. 6.

FIG. 8 is a cross-sectional view of a communication mechanism according to a first modified example.

FIG. 9 is a perspective view of a communication mechanism according to a second modified example.

FIG. 10 is a cross-sectional view of a configuration of a communication mechanism according to a third modified example, as viewed from the right.

### DETAILED DESCRIPTION OF EMBODIMENTS

An embodiment of the fishing reel according to the present disclosure will be described below with reference to the drawings. In each of the drawings, there are cases in which the scale of each component has been appropriately changed as required to improve the visibility of the component.

### Embodiment 1

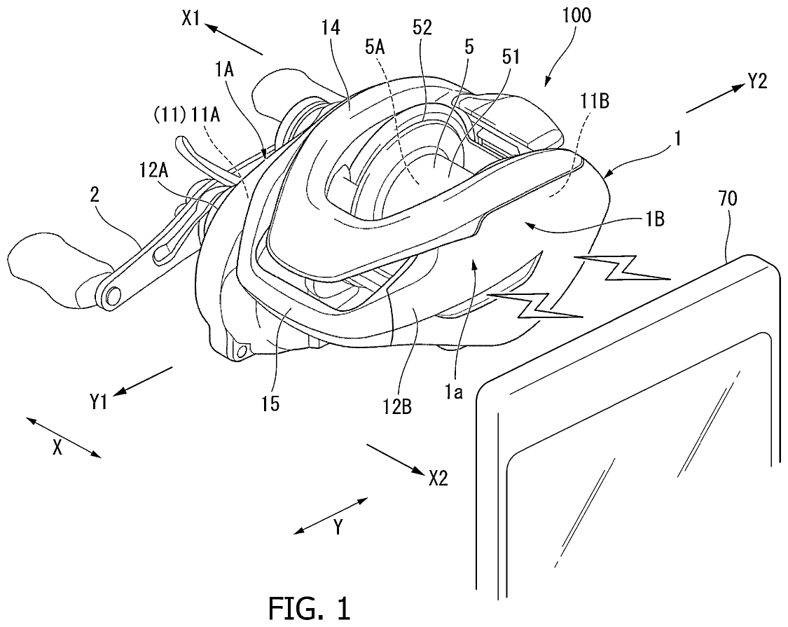

As shown in FIG. 1, a fishing reel of the present embodiment is illustrated as a dual-bearing reel 100.

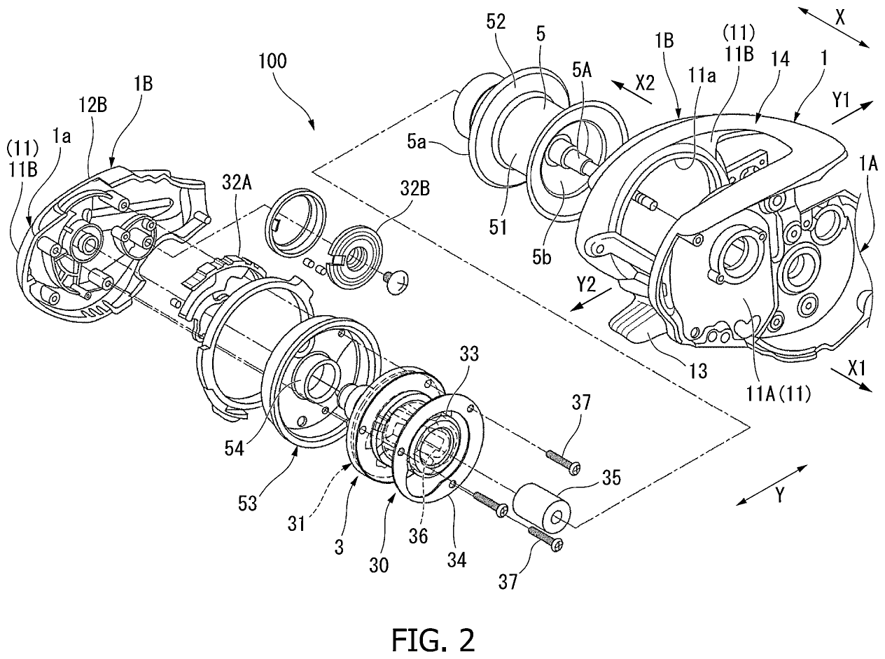

In the following description, “front/back,” “left/right,” and “up/down” refer to the directions shown in FIG. 1. That is, in the front-rear direction Y, the direction in which the fishing line is released is referred to as “front side Y1” and the direction in which the fishing line is wound is referred to as “rear side Y2.” In addition, in the left-right direction X, “right side X1” is a first portion side of the present disclosure and the side on which a handle 2 is disposed in the present embodiment (handle side), and “left side X2” is a second portion side of the present disclosure, and is a portion different from the first portion (palming side). In FIGS. 1 and 2, the front-rear and left-right directions are reversed.

The same elements are given the same codes in the explanation, and redundant explanations will be omitted.

The dual bearing reel 100 comprises a reel body 1, a handle 2, a spool 5, and a brake unit 3 (refer to FIG. 2) that electrically brakes the spool 5.

As shown in FIG. 1, the dual bearing reel 100 has a reel body 1 provided with left and right side plates 1A, 1B. The left and right side plates 1A, 1B are configured such that left and right frames 11 (11A, 11B) are respectively covered by side covers 12A, 12B. A reel foot 13 (refer to FIG. 2) that is mounted on a fishing rod (not shown) and that is positioned between the left and right side plates 1A, 1B is integrally formed with the reel body 1. In the present embodiment, the handle 2 for rotationally driving the spool 5 is installed on the right side plate 1A side (handle side). In addition, in the present embodiment, the outer surface portion of the left side plate 1B is referred to as a palming side portion 1a (palming side).

A spool shaft 5A is supported by a shaft bearing, between the left and right frames 11A, 11B so as to be rotatable. The spool 5, around which a fishing line is wound, is integrally fixed to the spool shaft 5A. In addition, a thumb rest 14, on which a finger can be placed, is disposed between the left and right side plates 1A, 1B above the spool 5.

The frame 11 has a right side plate 1A (i.e., a “first portion”) disposed on the handle 2 side, a left side plate 1B (i.e., a “second portion”) disposed on the opposite side of the right side plate 1A in the left-right direction, and a plurality of connecting portions 15 that connect the right side plate 1A and the left side plate 1B. The left side plate 1B has a circular opening 11a through which the spool 5 can pass. A detachable shaft supporting part 53 is disposed on the left side plate 1B of the frame 11.

The thumb rest 14 protrudes outward from the upper portions of the left and right pair of side plates 1A, 1B.

A rotation transmission mechanism (not shown) that transmits the rotation of the handle 2 to the spool 5, a drag mechanism, and a clutch control mechanism is disposed between the right side plate 1A and the first side cover 12A.

The handle 2 is supported by the reel body 1 so as to be freely rotatable. The spool 5 is disposed in the reel body 1 between the right side plate 1A and the left side plate 1B so as to be freely rotatable.

The spool 5 has a line winding part 5 around which the fishing line can be wound, and a cylindrical portion 52 that is integrally formed with the line winding part 51 and that is fixed to the spool shaft 5A. The spool shaft 5A is connected to the inner circumferential surface of the cylindrical portion 52 so as to be integrally rotatable therewith. One end 5a of the spool shaft 5A is supported on the shaft supporting part 53, described further below, by a shaft bearing 54 so as to be freely rotatable. The other end 5b of the spool shaft 5A is supported on the first side cover 12A by a shaft bearing (not shown) so as to be freely rotatable.

The shaft supporting part 53 supports one end 5a of the spool shaft 5A of the spool 5 so as to be freely rotatable. A shaft bearing 54 for supporting the one end 5a of the spool shaft 5A so as to be freely rotatable is provided at the center of the shaft supporting part 53.

The brake unit 3 includes a second side cover 12B that includes the shaft supporting part 53. The brake unit 3 comprises a braking part 30, a circuit board 31, adjustment mechanisms 32A, 32B that adjust the braking force of the braking part 30, a cover member 33, and a magnetic flux shielding member 34.

The braking part 30 includes a braking magnet 35 that is integrally rotatable with the spool 5, and a plurality of coils 36 that are cylindrically arranged at prescribed intervals on the outer peripheral side of the braking magnet 35 and that are connected in series. The coil 36 is one example of a conductor. The braking magnet 35 is mounted on the spool shaft 5A so as to be integrally rotatable therewith. In this embodiment, the braking magnet 35 is fixed to the spool shaft 5A by adhesion. The braking magnet 35 is a cylindrical magnet. The plurality of coils 36 are mounted on the circuit board 31. The two ends of the plurality of coils 36 that are connected in series are electrically connected to the circuit board 31. In this embodiment, four of the coils 36 are provided. Each of the coils 36 is curved in an arc shape, and the plurality of coils 36, as a whole, has a cylindrical shape.

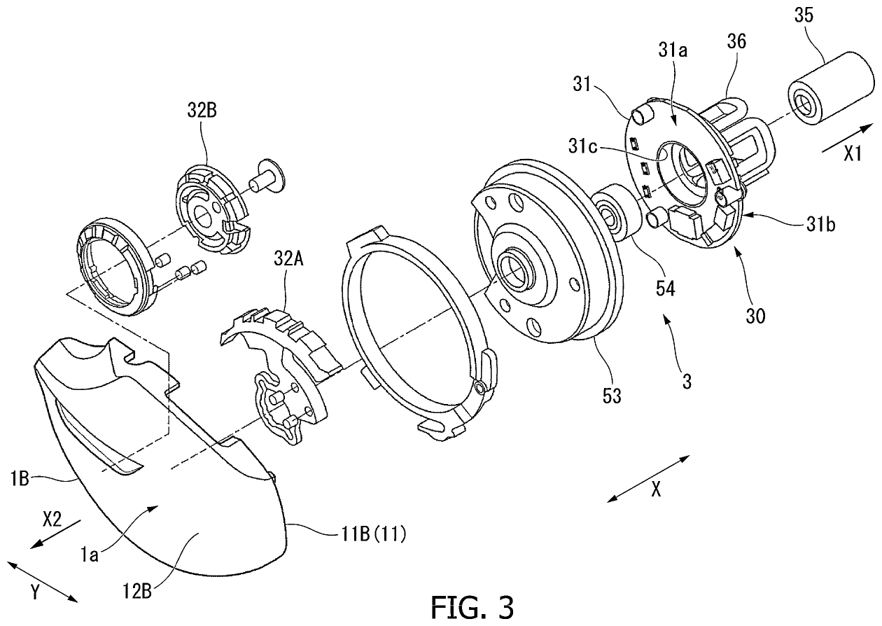

As shown in FIG. 3, the circuit board 31 is formed in a disk shape having a through-hole 31c. The circuit board 31 is mounted on a surface opposing the spool 5 on the outer peripheral side of the shaft supporting part 53. The circuit board 31 has a first surface (front surface 31a) on which the coils 36 are mounted, and a second surface (rear surface 31b) on the opposite side of the front surface 31a. The circuit board 31 is fixed, together with the shaft supporting part 53, the cover member 33, and the magnetic flux shielding member 34, to the left side cover 12B by bolt members 37, shown in FIG. 2.

The cover member 33 is a stepped cylindrical member made of synthetic resin, provided in order to insulate the circuit board 31, the coils 36, and electric components mounted on the circuit board 31.

The magnetic flux shielding member 34 is, for example, a member made of an iron plate. At least a portion of the magnetic flux shielding member 34 is provided on the front surface 31a of the circuit board 31. The magnetic flux shielding member 34 shields the magnetic flux of the braking magnet 35.

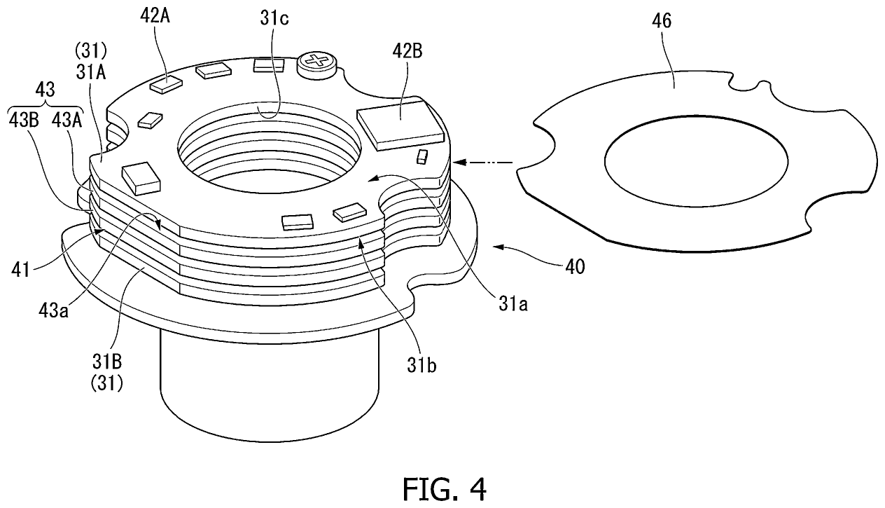

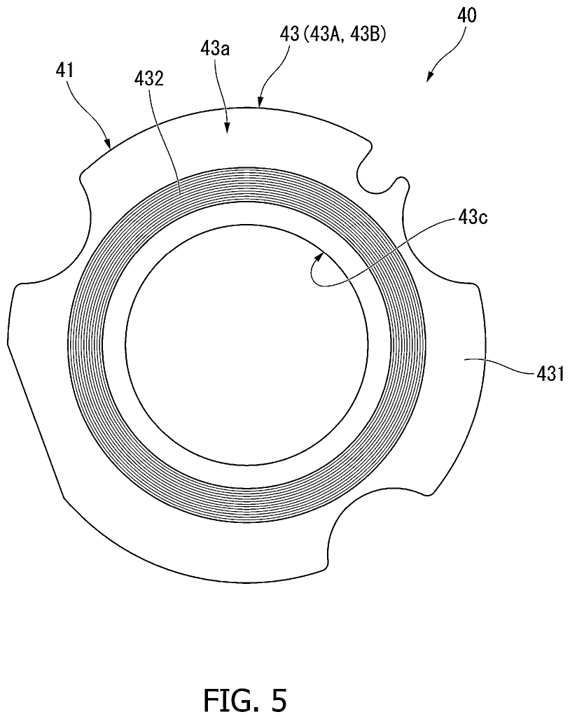

FIG. 4 is a partially exploded perspective view of a communication mechanism 40. FIG. 5 is a plan view of an antenna portion 43 of the communication mechanism 40 shown in FIG. 4.

As shown in FIGS. 4 and 5, the communication mechanism 40 for communicating information with an external terminal device 70 (corresponding to the “electronic device” in the claims) shown in FIG. 1 is disposed on the palming side (palming side portion 1a side) of the reel body 1. The communication mechanism 40 comprises a storage unit 42A that is disposed in the reel body 1 and stores setting information, an antenna unit 41 (i.e., a “communication unit” or communicator) that is disposed on the left side plate 1B and that can communicate with the terminal device 70, and a control unit (controller) 42B that causes the antenna unit 41 and the terminal device 70 to communicate when the antenna unit 41 and the terminal device 70 enter a field in which Near Field wireless Communication is possible, and updates the setting information of the storage unit 42A.

The communication mechanism 40 employs Near Field wireless Communication, such as NFC (Near Field Communication).

The terminal device 70 is used by a user who is an angler. The terminal device 70 can be, for example, a smartphone, a tablet terminal, or the like.

As shown in FIG. 4, the circuit board 31 described above is composed of a pair of circuit boards 31A, 31B. The antenna unit 41 functions as an antenna for wireless communication, and is stacked sandwiched between the pair of circuit boards 31A, 31B. The antenna unit 41 includes a plurality of layers (two layers here) of the antenna portion 43 (43A, 43B) on which the pattern coil 432 is formed. The antenna portion 43 is a multilayer antenna portion on which a plurality of layers of the pattern coil 432 is formed. That is, the antenna portion 43 has a substrate body 431 made of resin, or the like, in the form of a thin plate, and a pattern coil 432 printed on one surface (front surface 43a) of the substrate body 431.

The connection between the pattern coils 432 of the plurality of layers of the antenna portion 43, the connection between the pattern coil 432 and, for example, a tag IC provided on the antenna portion 43, and the like, can be achieved using the BtoB method or the pin method.

The antenna portions 43A, 43B are each configured to have an annular shape, and are provided around the spool shaft 5A that is supported by the reel body 1 when viewed from the left-right direction. The substrate body 431 includes a through-hole formed to have essentially the same diameter as the circuit board 31, and is stacked coaxially with the circuit boards 31A, 31B.

The pattern coil 432 is an antenna element that is formed on the front surface 43a of the antenna portion 43 by printing a conductive material.

In this manner, the antenna portion 43 is arranged in the vicinity of an inner surface 12a of the left side cover 12B of the left side plate 1B. As a result, by bringing the terminal device 70 close to, or in contact with, the left side plate 1B, as shown in FIG. 1, the terminal device 70 comes within a distance over which information can be communicated with the antenna unit 41, so that information can be communicated therebetween.

In addition, as shown in FIG. 4, the antenna portions 43A, 43B include or field attached to a shielding sheet 46 (shielding part) that has radio-shielding properties Here, radio-shielding properties refer to portions with relatively low radio wave transmittance compared to portions that have radio wave transmittance. The shielding sheet 46 is arranged between the antenna portion 43 and the circuit board 31. The shielding sheet 46 is formed in an annular shape having essentially the same shape as the substrate body 431 of the antenna portion 43 in plain view.

The storage unit 42A and the control unit 40 are mounted on the circuit board 31 of the communication mechanism 40. The storage unit 42A includes, for example, a semiconductor memory, and stores programs and data used for operation, and results of calculations performed by the control unit 42B.

The control unit 42B can include, for example, a transmission unit. In this case, the control unit 42B can output, as transmission data from the transmission unit, to an output unit (not shown) disposed in the reel body 1. For example, the output unit is a unit that presents images, sounds, vibrations, etc., to the user of the dual bearing reel 100, such as a speaker or a display function unit, such as a liquid crystal display, that can be viewed by the angler.

The action of the dual bearing reel 100 configured in this manner will be described in detail next, based on the drawings.

The dual bearing reel 100 according to the present embodiment comprises: the reel body 1; the handle 2 disposed on the first portion of the reel body 1; the storage unit 42A that is disposed in the reel body 1 and that stores setting information; the antenna unit 41 that is disposed in the second portion, which is separate from the first portion, and that can communicate with the external terminal device 70; and the control unit 42B that causes the antenna unit 41 and the terminal device 70 to communicate when the antenna unit 41 and the terminal device 70 enter a field in which Near Field wireless Communication is possible, and that updates the setting information of the storage unit 42A.

By the dual bearing reel 100 according to the present embodiment, if the terminal device 70, such as a smartphone, is brought close to the left side plate 1B (portion where the handle 2 is not provided) of the reel body 1 of the dual bearing reel 100, the antenna unit 41 being incorporated in said left side plate 1B, Near Field wireless Communication is performed between the storage unit and the electronic device via the antenna unit 41, and the electronic device can receive a supply of power and update the setting information stored in the storage unit.

In addition, in the present embodiment, since the antenna unit 41 is disposed on the left side plate 1B, which is the palming side and not the handle 2 side, it is easier to bring the terminal device 70 close to the antenna unit 41 disposed on the palming side portion, and to more reliably perform Near Field wireless Communication.

Additionally, in the present embodiment, the antenna unit 41 is configured to have an annular shape and is disposed around the spool shaft 5A that is supported by the reel body 1.

As a result, the space around the spool shaft 5A of the circuit board 31 can be used to dispose the antenna unit 41, as in the present embodiment. That is, because the antenna unit 41 can be disposed on the circuit board 31, the thickness dimension of the dual bearing reel 100 in the left-right direction can be reduced.

In addition, in this case, the antenna unit 41 can be disposed at a position that avoids a spool shaft supporting portion, such as a shaft bearing, and it is possible to reliably perform communication while minimizing protrusion toward the palming side.

Additionally, in the present embodiment, the antenna unit 41 is the antenna portion 43 on which the pattern coil 432 is formed, so that it is easy to form the pattern coil 432 by printing conductive paint, for example, on the substrate body 431. It is thereby possible to stack the antenna portion 43 on the circuit board 31, which has the advantage that the antenna shape can be made into a desired shape using the pattern coil 432. In this case, it is possible to more efficiently use the space of the antenna unit 41 disposed inside the reel body 1.

In addition, in the present embodiment, the antenna portion 43 is a multilayer antenna portion on which a plurality of layers of the pattern coil 432 is formed, so that the inductor value can be increased.

Additionally, in the present embodiment, the shielding sheet 46 is disposed between the antenna unit 41 and the storage unit 42A.

As a result, it is possible to suppress the electrical impact of the antenna unit 41 to be smaller than that of the storage unit 42A, and to adjust the inductor value to be larger.

By the dual bearing reel 100 according to the present embodiment configured as described above, it is possible to install the antenna unit 41 so that communication efficiency is improved, while restricting or avoiding an increase in the size of the reel.

Another embodiment of the fishing reel according to the present disclosure will be described next. Compositional elements that have the same functions as the compositional elements of the above-described first embodiment are given the same codes and detailed descriptions thereof are omitted to avoid redundant descriptions.

### Embodiment 2

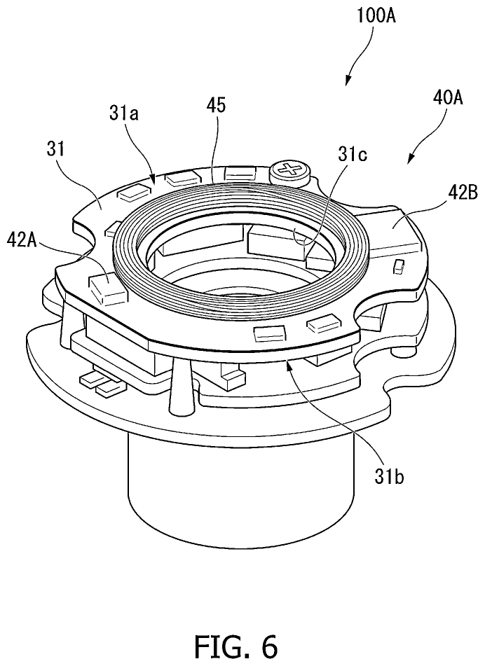

FIG. 6 is a perspective view showing the configuration of a communication mechanism 40A of a dual-bearing reel 100A according to a second embodiment.

As shown in FIG. 6, the communication mechanism 40A according to the second embodiment has a configuration in which an air core coil 45 (communication unit), made of enameled wire wound a plurality of times, is disposed on the front surface 31a of the circuit board 31 on the left side plate 1B side.

The air core coil 45 is wound in an annular shape along the circular through-hole 31c on the front surface 31a of the circuit board 31.

The air core coil 45 is disposed so as not to protrude in the radially inward direction of the through-hole 31c of the circuit board 31. The air core coil 45 has an overall cross-sectional diameter of, for example, 1.7-2.0 mm, and the number of turns of the annular winding is set to about 15 turns.

Any appropriate method, such as normal winding or α-winding, can be employed as the method of winding the enameled wire in the air core coil 45.

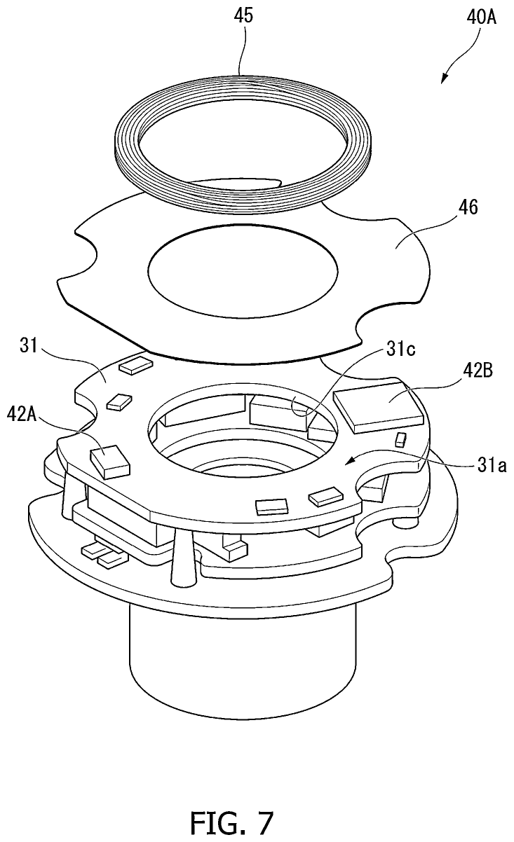

FIG. 7 is an exploded perspective view showing a configuration in which the shielding sheet 46 is disposed in the communication mechanism 40A shown in FIG. 6. In the communication mechanism 40A of the present embodiment, the shielding sheet 46 (shielding part) is disposed between the air core coil 45 and the storage unit 42A, as shown in FIG. 7.

In the second embodiment, since the air core coil 45 is simply disposed on the existing circuit board 31, assembly of the air core coil 45 can be easily carried out. It is a particularly effective structure if there is space in the height direction (left-right direction) above the circuit board 31.

### First Modified Example

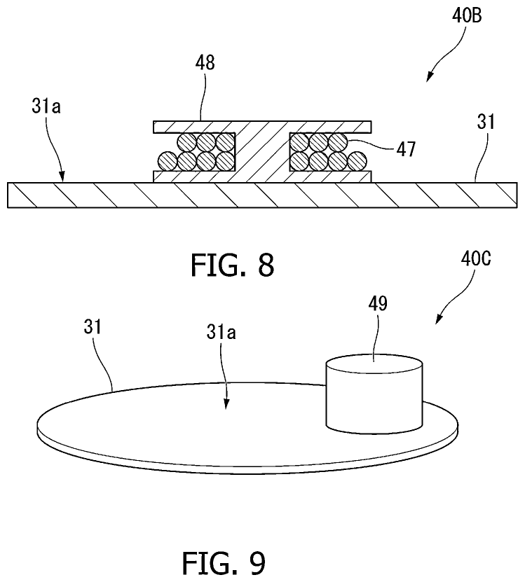

FIG. 8 is a cross-sectional view of a communication mechanism 40B according to a first modified example.

The communication mechanism 40B according to the first modified example shown in FIG. 8 has a configuration in which an air core coil 47 (communication unit) made of enameled wire is wound around a low-profile bobbin 48. That is, the low-profile bobbin 48 equipped with the air core coil 47 is fixed to the front surface 31a of the circuit board 31.

In the communication mechanism 40B according to the first modified example, a notch, or the like, is provided on the circuit board 31, and the start end and the finish end of the air core coil 47 are positioned in this notch, thereby making it possible to maintain a constant distance between the air core coil 47 and the circuit board 31 As a result, the inductor value can be maintained constant, and the communication state of the communication mechanism 40B can be stabilized.

### Second Modified Example

FIG. 9 is a cross-sectional view of a communication mechanism 40C according to a second modified example.

The communication mechanism 40C according to the second modified example shown in FIG. 9 has a configuration in which, instead of an antenna that extends in an annular shape over the entire circumferential direction of the front surface 31a of the circuit board 31, a small coil 49 (communication unit) with an increased number of winding turns is disposed in one part of the circumferential direction.

In the communication mechanism 40C according to the second modified example, the field in which the small coil 49 is disposed on the front surface 31a of the circuit board 31 can be reduced in size, making it an effective structure if there is space in the height direction (left-right direction) above the circuit board 31.

### Third Modified Example

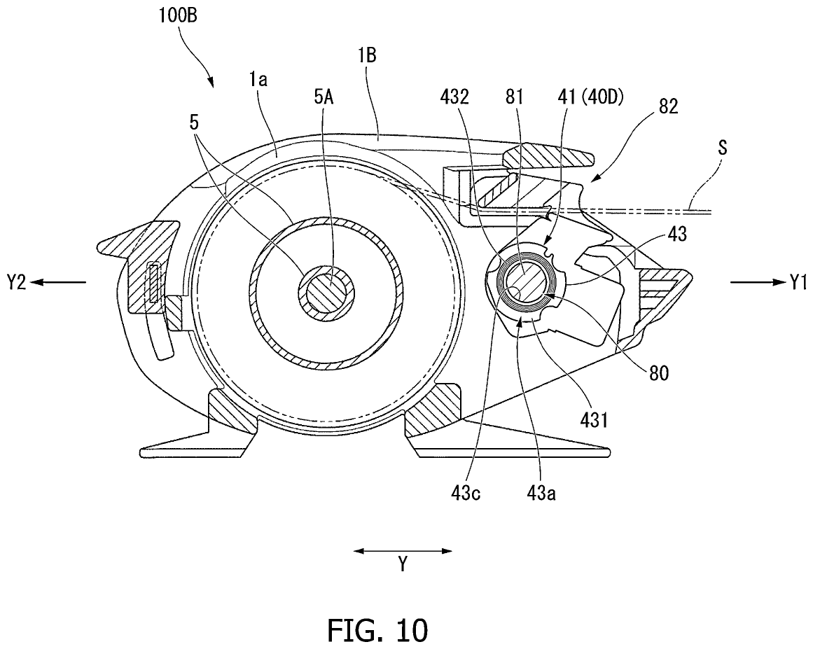

FIG. 10 is a cross-sectional view of a configuration of a communication mechanism 40D according to a third modified example, as viewed from the right.

In the third modified example shown in FIG. 10, it is possible to provide the antenna unit 41 (communication unit) of the communication mechanism 40D around a rotational shaft 81 of an annularly-shaped level winding device 80, which moves the line guide unit in reciprocating fashion, on the palming side portion 1a (left side plate 1B) on the opposite side of the handle 2 of an electric dual-bearing reel 100B (fishing reel).

The level winding device 80 has a line guide unit 82 through which a fishing line S is inserted. The line guide unit 82 is configured to move left and right in reciprocating fashion by rotation of the handle 2, and has a function of evenly winding the fishing line S around the spool 5 as the fishing line S is wound up. The line guide unit 82 is configured to be moved left and right in reciprocating fashion by the rotational shaft 81 that is supported, so as to be turnable, between the left and right side plates 1A, 1B (refer to FIG. 1) via a shaft bearing (not shown), and that serves as a drive shaft that is rotatably driven.

The antenna unit 41 is disposed on the inner side of the left side plate 1B. The antenna unit 41 forms the annularly-shaped antenna portion 43, in the same manner as in the first embodiment described above. The antenna portion 43 includes the substrate body 431, and the pattern coil 432 that is printed in an annular shape along a through-hole 43c on the front surface 43a of the substrate body 431.

In the case according to the third modified example, because the space extends along an extension line of the rotational shaft 81 of the level winding device 80, palming performance is not hindered or negatively impacted.

In addition, the configuration of the communication unit that is disposed around the rotational shaft 81 of the level winding device 80 is not limited to the antenna portion 43 on which the annularly-shaped pattern coil 432 is printed, as described above; for example, it is possible to dispose a communication unit composed of a small coil antenna with increased number of turns of the annular shape.

The above-described embodiment of the fishing reel according to the disclosure is presented as an example and is not intended to limit the scope of the disclosure. The embodiments can be implemented in a variety of other forms; furthermore, various omissions, substitutions and changes can be made without departing from the essence of the disclosure. Embodiments include those that can be easily conceived of by a person skilled in the art, those that are substantially the same, and those that are of equivalent scope.

For example, the position where a communication unit, such as the antenna unit 41, is disposed in the reel body 1 is not limited to the position of the left side plate 1B on the opposite side of the handle 2, which is provided on the right side plate 1A, as described above. That is, the communication unit can be provided at positions such as an inner layer of the substrate, on one side of the substrate, between the substrate and a case (side plates 1A, 1B of the reel body 1), in the case itself, or on the outer side of the case.

In addition, configurations such as the sizes and shapes of the reel body 1, the spool 5, the handle 2, the brake unit 3, and the like, can be changed as appropriate.

What is claimed is:

1. A fishing reel, comprising
a reel body having a first portion and a second portion which is separate from the first portion;
a handle disposed on the first portion of the reel body;
a storage unit disposed in the reel body and configured to store setting information;
a communication unit disposed in the second portion and configured to communicate with an external electronic device; and
a control unit configured to cause the communication unit and the electronic device to communicate when the communication unit and the electronic device are disposed in a field capable of enabling near field wireless communication, and configured to update the setting information of the storage unit.

2. The fishing reel according to claim 1, wherein
the second portion is disposed on a palming side which is an opposite side of the first portion, and
the communication unit is disposed on the palming side.

3. The fishing reel according to claim 1, wherein
the communication unit has an annular shape and is disposed around a spool shaft supported by the reel body.

4. The fishing reel according to claim 1, wherein
the communication unit has an annular shape and is disposed around a rotational shaft of a level winding device configured to move a line guide unit in reciprocating fashion.

5. The fishing reel according to claim 1, wherein
the communication unit has an antenna portion which is a pattern coil antenna.

6. The fishing reel according to claim 5, wherein
the antenna portion is a multilayer antenna which forms a plurality of layers of the pattern coil.

7. The fishing reel according to claim 1, wherein
the communication unit has an air core coil antenna which is enameled wire.

8. The fishing reel according to claim 1, wherein
a shielding part is disposed between the communication unit and the storage unit.
